(19) United States
(12) Patent Application Publication
(10) Pub. No.: US 2011/0011180 A1
(43) Pub. Date: Jan. 20, 2011

(54) SENSOR HOUSING ASSEMBLY FACILITATING SENSOR INSTALLATION, REPLACEMENT, RECOVERY AND REUSE

(76) Inventor: John WILSON, Phoenix, AZ (US)

Correspondence Address: MOETTELI & ASSOCIATES SARL, ST. LEONHARDSTRASSE 4, ST. GALLEN, CH-9000, CH

(21) Appl. No.: 12/836,682

(22) Filed: Jul. 15, 2010

Related U.S. Application Data
(60) Provisional application No. 61/226,319, filed on Jul. 17, 2009.

(51) Int. Cl. G01D 11/24

(52) U.S. Cl. 73/431

(57) ABSTRACT

An enclosed sensor assembly (10) for permanent mounting within a road (12) flush with the top surface (14) thereof, has a housing 16, a sensor 38 and an upper cover (44). The housing (16) has a flat bottom portion (20); first side wall portions (22) and second side wall portions (32). The first side wall portions (22) are attached to the flat bottom portion (20) at the periphery (24) thereof, which, together with the flat bottom portion, defines a sensor enclosing pocket (26) having an upper interface portion (30). The second side wall portions (32) are attached to the first side wall portions (22) and laterally extend from the first side wall portions so as to define at least one lateral epoxy receiving pocket (34). Optionally, dead spaces (36) adjacent the sensor pocket (26) are provided which help isolate the sensor pocket against entry of epoxy (30). The sensor (38) installs in the sensor pocket (26). The cover (44) has an upper cover interface (42) abutting against the upper interface portion (30) to substantially enclose the sensor enclosing pocket (26).

### CROSS REFERENCE TO RELATED APPLICATIONS

This application claims the benefit of U.S. Provisional Application No. 61/226,319, filed 17 Jul. 2009, the content of which is incorporated by reference hereto.

### COPYRIGHT & LEGAL NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### BACKGROUND OF THE INVENTION

This invention relates to a method of installation of a sensor in a road surface and the sensor assembly for use in such method.

Electronic sensors are a critical component in modern traffic management systems and perform tasks such as counting, measuring the rate of traffic throughflow, weighing, and triggering other functions in a wide variety of applications that make driving safer or improve its efficiency. New sensor types also undergo testing and so must be installed, operated and later removed for inspection and data gathering. These sensors are usually installed in the pavement of streets, flush with the street surface.

Prior art documents U.S. Pat. No. 5,668,540; U.S. Pat. No. 4,799,381; U.S. Pat. No. 4,712,423; and U.S. Pat. No. 4,383239 disclose sensors surrounded by one or more rigid and/or resilient holder materials. These sensor/holder units are embedded within a road surface in an essentially permanent manner, i.e. the sensor holder unit is fixed, even encased, in a road surface recess by a matrix material such as resin, epoxy, etc. As a result, sensor removal is likely to cause sensor destruction.

U.S. Pat. No. 5,008,666; U.S. Pat. No. 5,710,554, and U.S. Pat. No. 5,686,841 disclose sensors surrounded by one or more rigid and/or resilient holder materials. However, the embedding of the sensor described in these documents is of a less permanent nature, i.e. the “naked” sensor or the sensor with some sensor enclosure surrounding it is easily removable from the holder which, just as in the above-mentioned prior art references, is fixed within the road surface recess. These references do not use epoxy to enclose the sensor. Although one or two show a flat bottom, none describe the advantage of having a flat lower surface for the purpose of easily leveling the sensor.

U.S. Pat. No. 5,710,554 describes a cylindrical enclosure for a sensor with a flat bottom, which could be used to facilitate leveling. However, there is no epoxy use at all discussed here, probably should not be used here because of the need that the cover remain permeable.

In sum, the above documents show sensors in a housing. In some cases, the sensore are removeable from the housing. Further, it is known in the art to use epoxy for embedding sensors.

Using known prior art technology, recovery attempts for sensors often fail because the sensor is embedded in epoxy or epoxy used to fix the sensor often seeps into the housing, contaminating the label or making intact removal of the sensor impossible. Whether or not successful, the removal attempt requires about one and a half hours per sensor. Even if successfully removed, the acceptance rate for these sensors is only about 80 percent.

Still further, in order to remove a sensor using prior art methods, a chisel blade in the drill is used to chisel all around the edge of the sensor. Typically, one must chisel down the full depth of the hole in order to get the epoxied sensor loose from the hole. After removing the epoxied sensor, time and effort must be expended to cut up the removed “block” in order to remove sufficient epoxy to e able to open the sensor for repair. Sensor manufacturers require their customers to remove sufficient epoxy and/or encased asphalt in order to open the sensor housing (usually of clam shell design), thus permitting sensor repair.

What is needed therefore is a sensor assembly and installation/replacement or removal procedure that better ensures that the sensor label is intact, that the sensor can be separated from its encasing and that the old sensor is not damaged when removed for repair or replacement.

### SUMMARY OF THE INVENTION

An enclosed sensor assembly for essentially permanent mounting within a road flush with the top surface thereof, has a housing a sensor and an upper cover. The housing has a flat bottom portion; first side wall portions and second side wall portions. The first side wall portions are attached to the flat bottom portion at the periphery thereof, which, together with the flat bottom portion, defines a sensor enclosing pocket having an upper interface portion. The second side wall portions are attached to the first side wall portions and laterally extend from the first side wall portions so as to define at least one lateral epoxy receiving pocket. Optionally, dead spaces adjacent the sensor pocket are provided which help isolate the sensor pocket against entry of epoxy. The sensor installs in the sensor pocket. The cover has an upper cover interface abutting against the upper interface portion to substantially enclose the sensor enclosing pocket.

An object of the invention is to provide a sensor assembly that facilitates sensor recovery such that the sensor is recovered in an undamaged, refurbishable, reuseable, or resalable condition.

Another object of the invention is to provide a sensor assembly and method of installation and removal that permits sensor recovery and reuse.

### BRIEF DESCRIPTION OF THE DRAWINGS

FIG. 1A is a perspective view of a first embodiment of the invention having a square sensor housing.

FIG. 1B is a top perspective view of a prototype housing of the invention.

FIG. 2 is a flow chart of the method of installation of the invention.

FIG. 3A is a perspective view of the housing of the invention installed in a pavement hole.

FIG. 3B is a second perspective view of the housing of the invention installed in a pavement hole, with a corrugated cover.

FIG. 3C is a perspective view of step of the method of the invention, inserting epoxy in an epoxy pocket of the housing and the housing and sensor installed in the hole.

FIG. 3D is a perspective view of the cover being placed in the hole.

FIG. 3E is a perspective view of the installed sensor assembly, with the epoxy being poured over the cover.

FIG. 3F is a perspective view of the completed installation of the assembly of the invention, epoxy applied over the cover to seal the assembly in the hole.

FIG. 4A is a perspective view showing the installation of a seal, an optional step of the method of the invention.

FIG. 4B is perspective view of the optional seal of the invention.

FIG. 4C is a perspective view of the step of injecting epoxy over the cover of the invention.

FIG. 5 is a flow chart of the method of removal of the invention.

FIG. 6A is a perspective view of a step of the method of removal of the sensor assembly of the invention, wherein the cover has been removed using a chisel and the sensor is subsequently removed from the hole.

FIG. 6B is a perspective view of the step of the method of removal of the sensor assembly of the invention, wherein the cover has been removed and the underside of the cover is visible, showing how little epoxy was able to seap past the cover and enter the sensor pocket.

FIG. 7 is a perspective view of another embodiment of the invention having a round sensor housing.

FIG. 8 is a perspective view of another embodiment of the invention having a triangular sensor housing.

Those skilled in the art will appreciate that elements in the Figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended for distinguishing between similar elements and not necessarily for describing a sequential or chronological order. Moreover, relative terms like ‘front’, ‘back’, ‘top’ and ‘bottom’, and the like in the Description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENT

The following description is not intended to limit the scope of the invention in any way as they are exemplary in nature and serve to describe the best mode of the invention known the inventors as of the filing date hereof. Consequently, changes may be made in the arrangement and/or function of any of the elements described in the disclosed exemplary embodiments without departing from the spirit and scope of the invention.

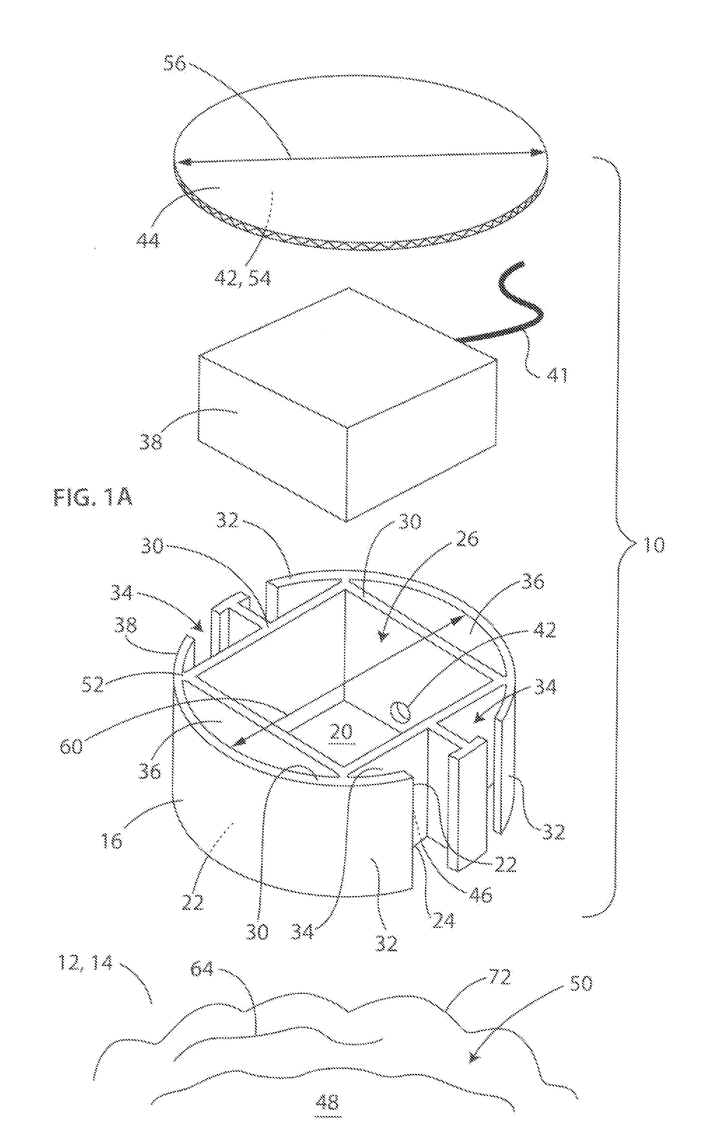

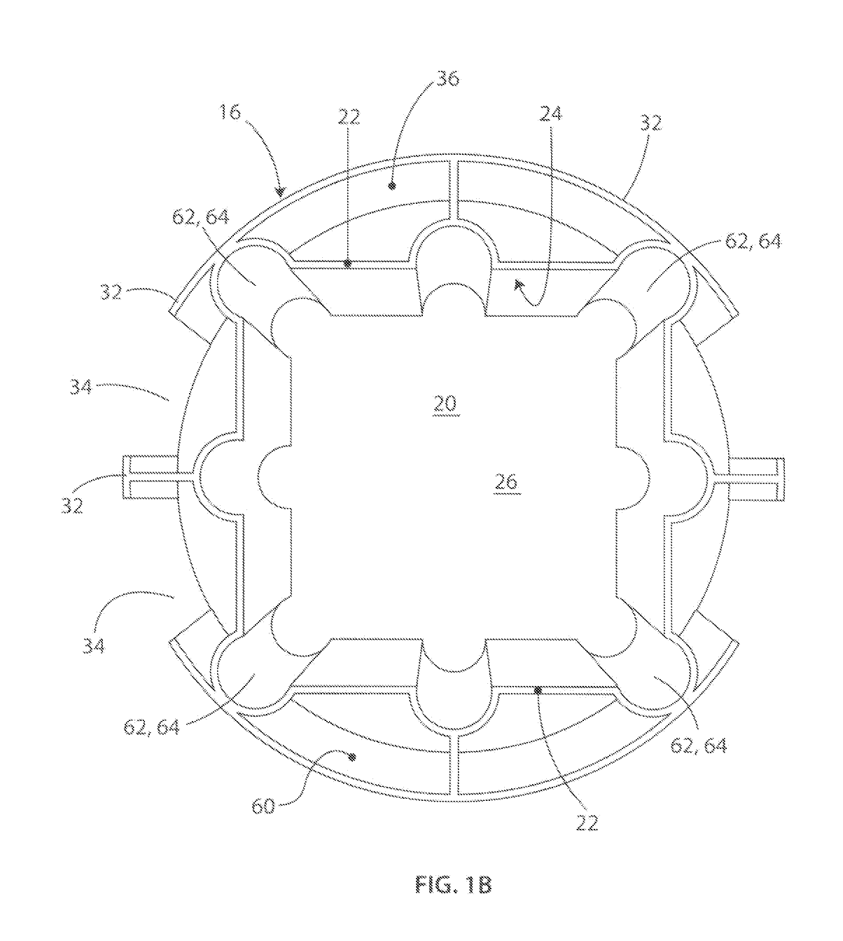

Referring now to FIG. 1A, an enclosed sensor assembly 10 for essentially permanent mounting within a road 12 flush with the top surface 14 thereof, has a housing 16, a sensor 38 and an upper cover 44. The housing 16 has a flat bottom portion 20, first side wall portions 22 and second side wall portions 32. The first side wall portions 22 are attached to the flat bottom portion 20 at the periphery 24 thereof, which, together with the flat bottom portion, defines a sensor enclosing pocket 26 having an upper interface portion 30. The second side wall portions 32 are attached to the first side wall portions 22 and laterally extend from the first side wall portions so as to define at least one lateral epoxy receiving pocket 34. Optionally, dead spaces 36 adjacent the sensor pocket 26 are provided which help isolate the sensor pocket against entry of epoxy 40. The sensor 38 installs in the sensor pocket 26. The cover 44 has an upper cover interface 42 abutting the upper interface portion 30 to substantially enclose the sensor enclosing pocket 26.

Where a wireless sensor is not used, an access hole 42 is provided for sensor wires 41 for power and/or communication to pass through, for connecting to other devices (not shown).

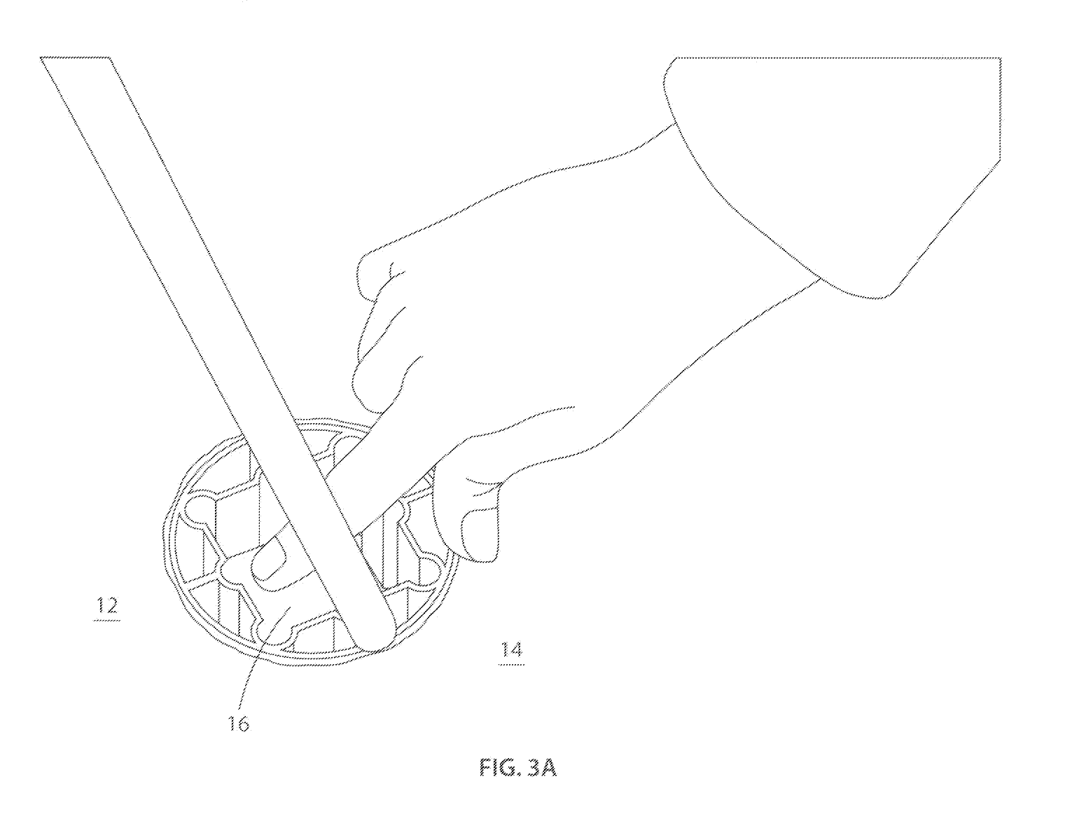

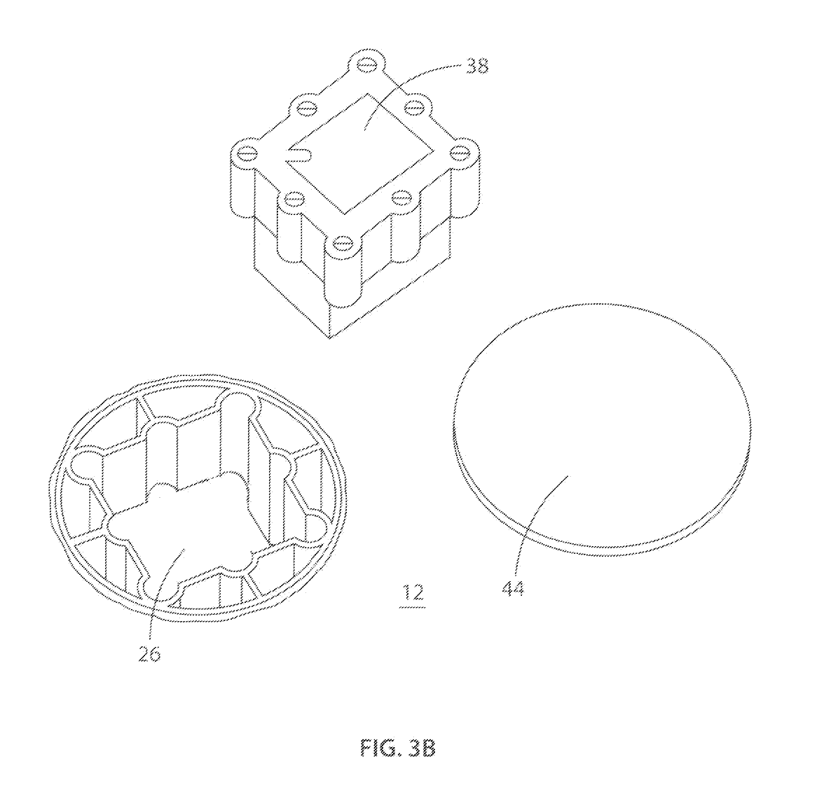

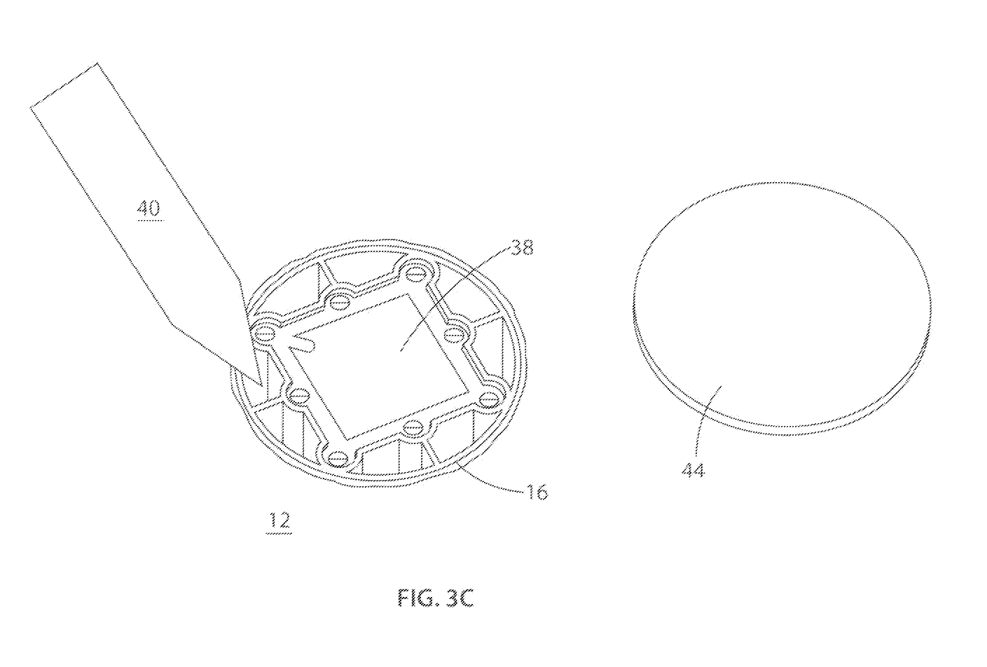

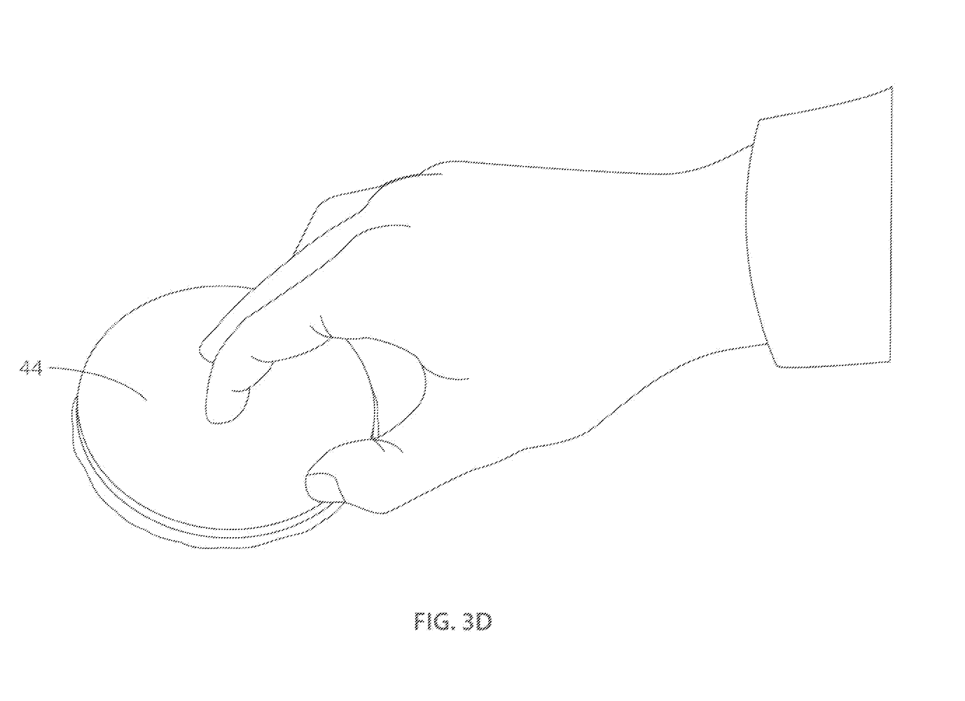

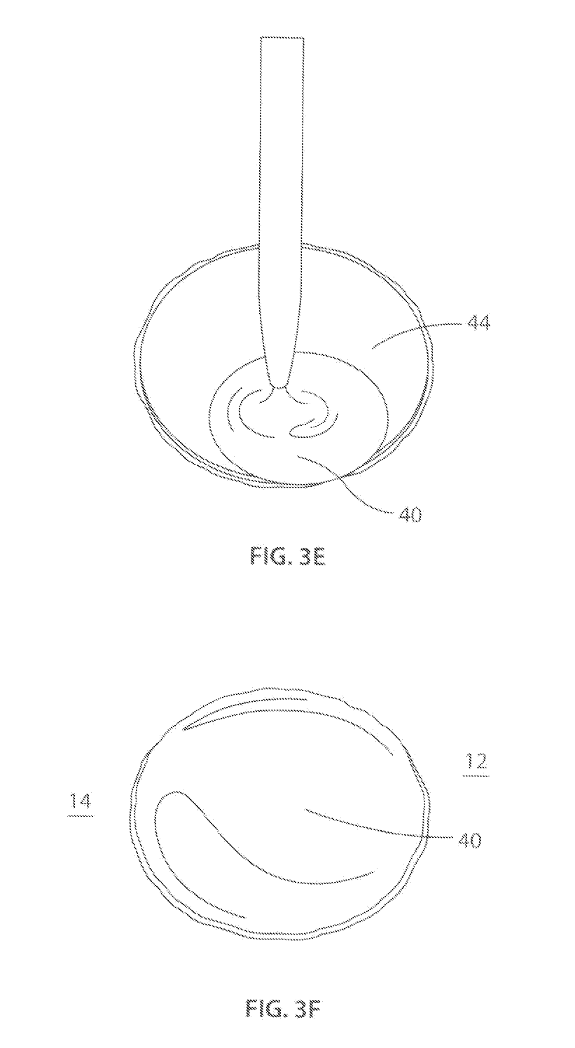

A flat surface 46 of the flat bottom portion 20 of the housing 16 aids in aligning the housing 16 against a lower flat surface 48 of a sensor assembly receiving hole 50 (see also FIGS. 3C and 3D). Epoxy 40 may be injected into the epoxy receiving pockets 34. The epoxy 40 in the epoxy receiving pockets 34 holds the assembly 10 against rotation in the sensor assembly receiving hole 50. The upper interface portion 30 comprises a flat upper surface 52. The upper cover interface 42 comprises a corresponding flat surface 54. The upper cover interface 42 has a diameter 56 greater than a diameter 60 of the upper interface portion 30 and is preferably made of corrugated plastic. This corrugated plastic cover 44 is cut to the same size as the sensor assembly receiving hole 50 (see also FIG. 3D). This tight fit helps with keeping a majority of the epoxy 40 above the plastic cover 44. The corrugated material is advantageously used so that if any epoxy 40 flows down toward the sensor 38, it will “wick” into the corrugation which helps keep epoxy 40 from coating the top side of the sensor 38.

Referring now to FIG. 1B, a square pocketed sensor housing 16′ is shown. Note that there are cylindrical recesses 62 at the corners 64 of the sensor housing 16′ to snuggly conform to the exterior form of the sensor 38.

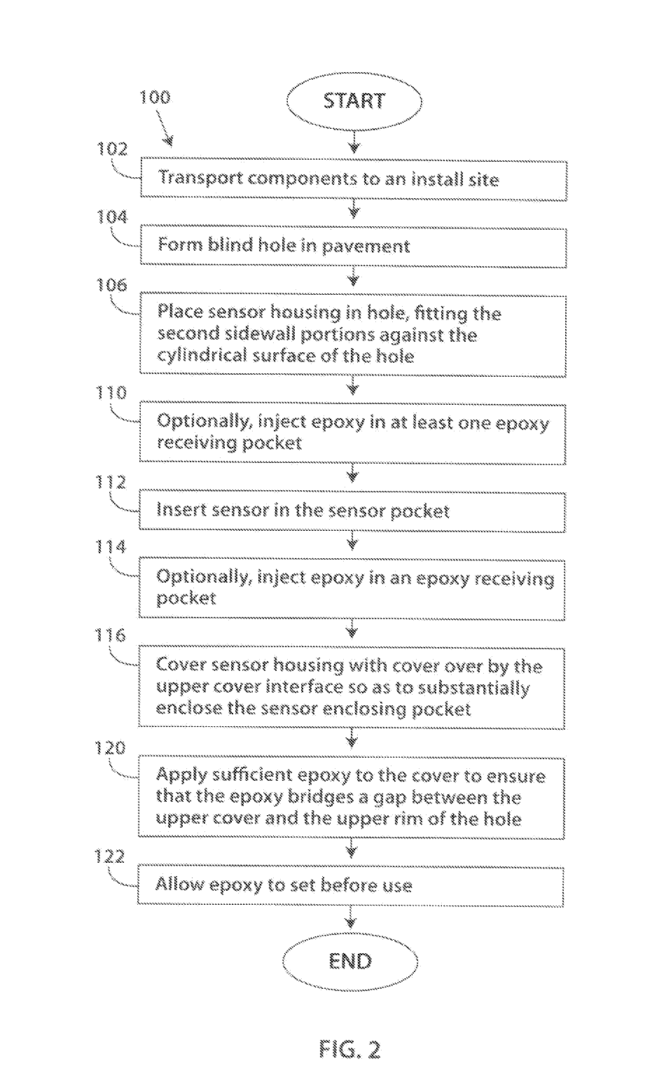

Referring now to FIGS. 2 and 3A-3F, the method 100 of installation of the sensor assembly 10 of the invention includes the steps of: boring a blind hole 50 of sufficient size at the location in which the sensor assembly 10 is to be installed (not shown), cleaning the hole of excess lose dirt and debris, inserting the sensor housing 16 in the bored hole 50, optionally, inserting epoxy 40 in the epoxy receiving pockets 34, inserting the sensor 38 in the sensor pocket 26, optionally connecting any wiring, fitting a cover 44 against the upper cover interface 42, injecting or pouring epoxy over the cover 44 until the epoxy 40 fills exposed holes and allowing to the epoxy to set. The sensor 38 is thereby completely sealed against the elements.

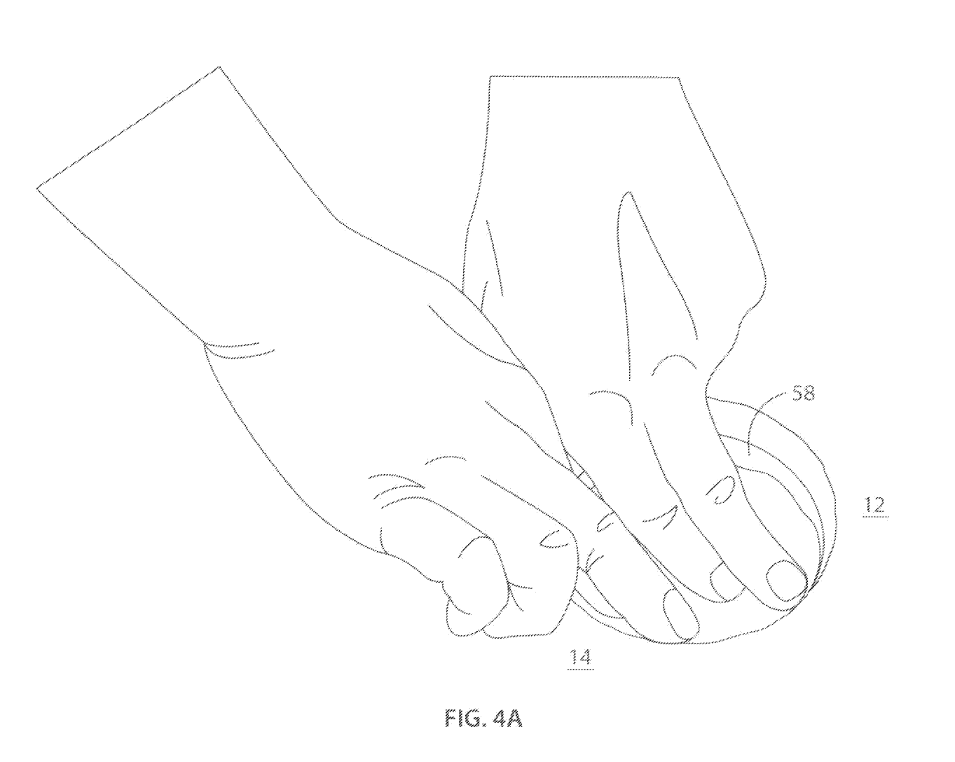

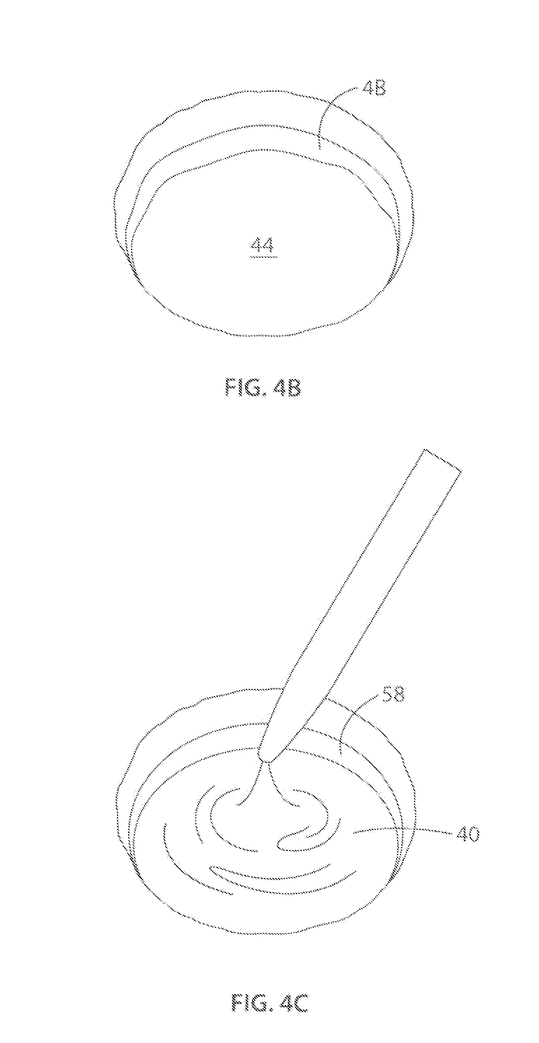

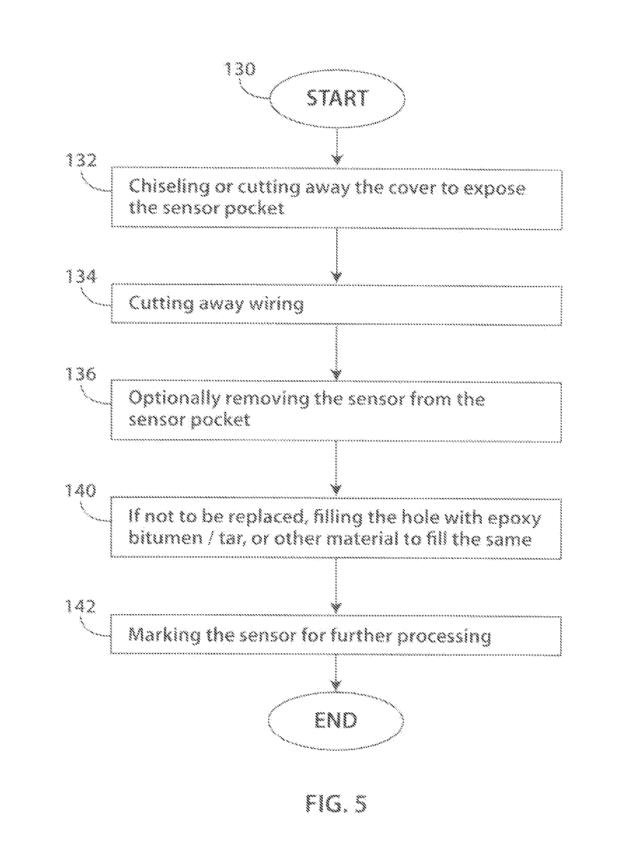

Alternatively, referring to FIGS. 4A-4C, a variation on the above mentioned method 100 may be made which results in facilitiated removal and replacement of a sensor 38 from the sensor housing 16, after the sensor assembly 10 has been fully installed. In this alternate method, little or perhaps no epoxy 40 is injected in the epoxy receiving pockets 34 (see FIG. 3E above). After inserting the sensor 38 in the sensor pocket 26, optionally connecting any wiring, and after placing the cover 44 against the upper cover interface 42 of the housing, a seal 58 such as a long, rolled band of duct seal putty or pre-formed and elongated window glazing is installed along the interface between the cover 44 and the adjacent wall of the hole 50. After the seal 58 is firmly in place (see FIGS. 4B and 4C), epoxy 40 is injected or poured over the cover 44 until the epoxy 40 covers the cover 44. The epoxy 40 is then allowed to set. The seal 58 therefore ensures that the epoxy remains above the housing and does not seap into the housing, making replacement of a damaged or malfunctioning sensor 38 which was installed in this way, easier to remove.

Note that after boring the hole 50, there is usually loose dirt in the bottom of the hole. In order to not have to remove all of the dirt by hand (in order to be assured that the sensor 38 is sitting flat), the housing 16 has a bottom 20 that, together with the cylindrical side walls which orient the housing perpendicular to the ground, helps ensure the sensor 38 is sitting properly (flat) for every installation.

The epoxy pockets 34 allow for filling with epoxy 40, for example, FABICK™ Epoxy, and bonding with the side wall 64 of the drilled hole 50. This helps keep the sensor 38 from rotating in the hole 50. Depending on the sensor 38 and it's purpose, it may be critical for the sensor to be oriented properly. For instance, it may be necessary to orient the sensor 38 so that an arrow noted on the sensor is oriented with the direction of traffic flow.

Referring again to FIG. 2, in more detail, the method 100 of the invention of installing a road sensor 38 includes the following steps. In a first step 102, the sensor assembly 10 of the invention is transported to an install site, along with a sensor 38, epoxy 40 and appropriate tools (e.g. chisel 66, hammer, etc.). In a second step 104, a blind hole 50 is formed, such as by boring. The blind hole 50 has a substantially flat bottom 70 to a depth that approximates a height of the sensor housing 16 plus the thickness of the cover 44 (and further a depth to accommodate debris), and of a diameter 56 larger than a diameter 60 of the sensor housing 16. In a third step 106, the sensor housing 16 is placed in the hole 50. The fit of the second sidewall portions 32 against the cylindrical surface 64 of the hole 50 is tight enough to orient the sensor assembly 10 independent on the flatness of the lower surface 70 of the hole 50 (consequently, debris remaining at the bottom of the hole does not affect the flatness of the bottom surface of the sensor housing 16). Thus, the cylindrical sidewalls 32 orient themselves with the corresponding cylindrical surfaces 64 of the bored hole 50. In a fourth step 110, optionally, epoxy 40 is injected in at least one epoxy receiving pocket 34. In a fifth step 112, a sensor 38 is inserted in the sensor pocket 26 of the sensor housing 16. In a sixth step 114, optionally, epoxy 40 is injected in an epoxy receiving pocket 34. In a seventh step 116, the sensor housing 16 is covered by the upper cover interface 42 so as to substantially enclose the sensor enclosing pocket 26. In a eighth step 120, sufficient epoxy 40 is applied to the cover 44 to ensure that the epoxy 40 bridges a gap 118 between the tipper cover 44 and an upper rim 72 of the hole 50, consequently sealing the sensor 38 in the sensor receiving pocket 26 and, if not already done, applying sufficient epoxy 40 to enter and fill the at least one epoxy receiving pocket 34. In a ninth step 122, the epoxy 40 to allowed to set before use.

In an alternate embodiment of the method 100, before, after or during the fifth step 112, to the method includes the step of passing any sensor wires 41 for power and/or communication through an access hole 42 hole in the housing 16, for connecting to other devices (not shown).

In an alternate embodiment of the method 100, the method 100′ is identical to the method 100 described above except that it includes a step between steps 114 and 116 of cutting the upper cover to tightly fit an upper portion of the hole 50 while abutting against the upper interface 30 of the housing 16 so as to prevent seepage of epoxy into the sensor pocket 26. Where the upper cover 44 is made of corrugated plastic, cutting is facilitated. Further, cutting exposes corrugation channels 74 which wick excess epoxy away 30 from the sensor pocket 26.

The precise fit to the opening of the hole 50 minimizes the amount of epoxy seepage into the cavities below and therefore minimize the likelihood of contamination of the sensor 44 thereby.

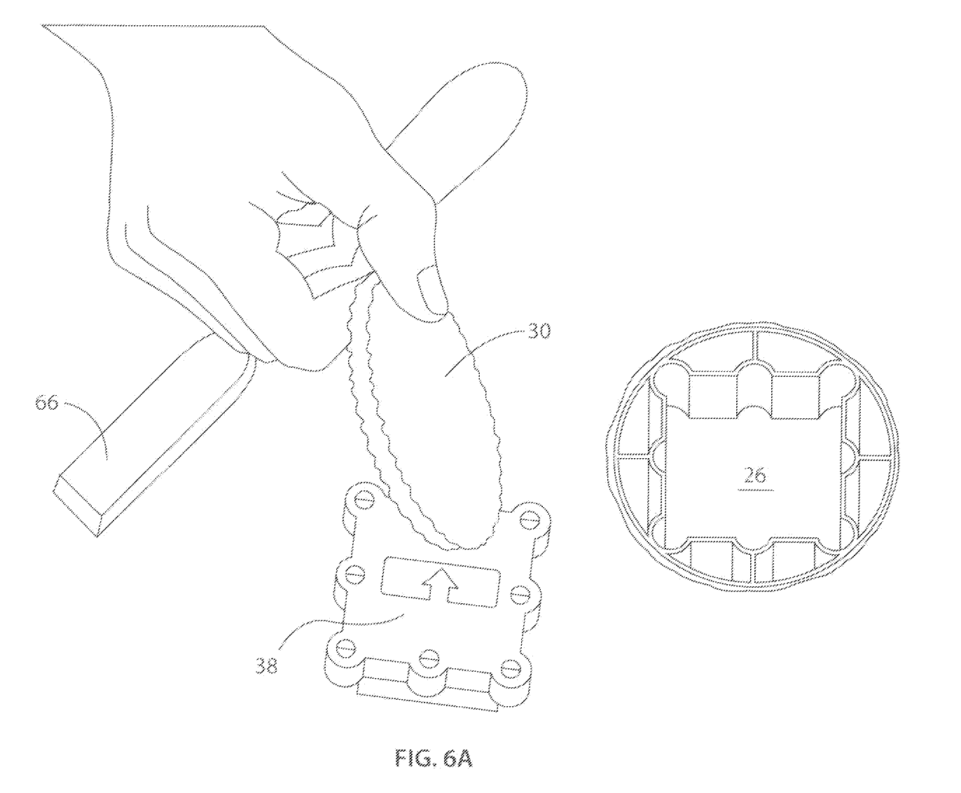

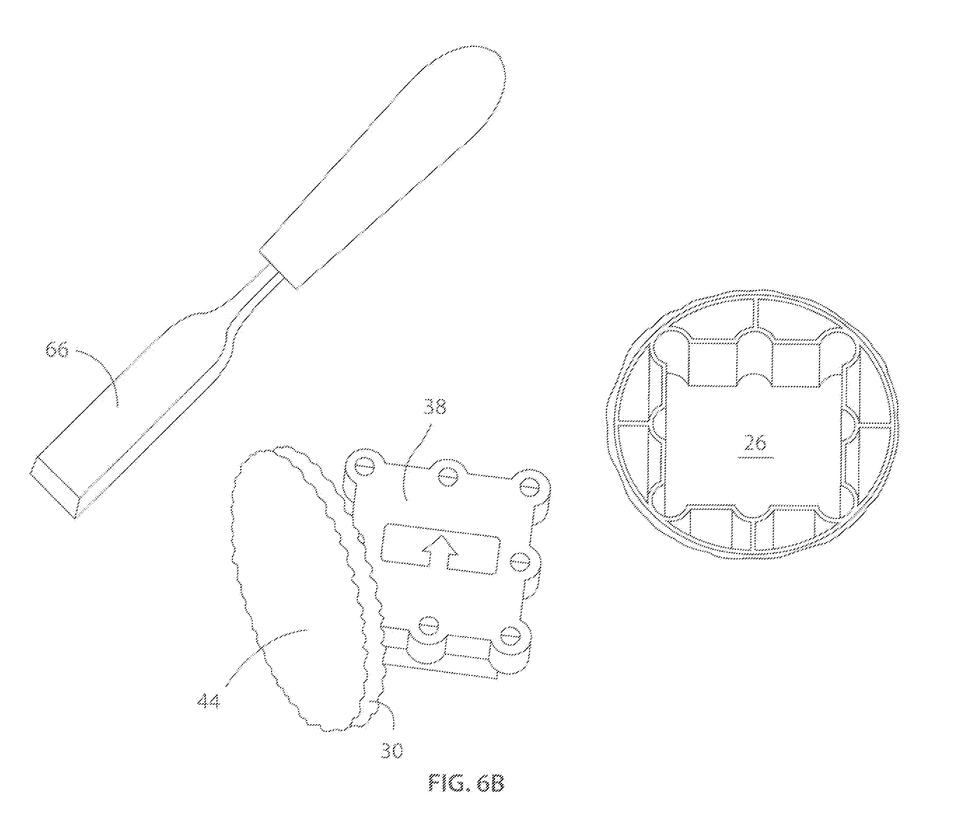

Referring now to FIGS. 5-6A & 6B, the method 130 of removing and recovering the sensor 38 from the sensor assembly 10 includes: in step 132, chiseling, or cutting away the epoxy 30 so as to free the cover 44 to expose the sensor pocket 26, in optional step 134, cutting any wiring (if any), in step 136, removing the sensor 38 from the sensor pocket 26, in step 140, if not to be replaced, filling the hole 50 with epoxy 40, bitumen/tar, or other material to fill the same, and, in step 142, marking the sensor 38 for further processing (disposal, reuse elsewhere, refurbishment and resale, etc.). The cutting away of the cover 44 can be accomplished using a chisel 66 and hammer, by chiseling around the top edge 76 of the installed sensor assembly 10. The chisel 66 can be used to pry up the epoxied cover 44 and remove or replace the sensor 38.

If the sensor 38 is replaced, a new sensor is installed in the sensor pocket 26, and a replacement sensor cover 44 is set in place and epoxy 40 is applied over the cover 44, filling the void until it is flush with the pavement.

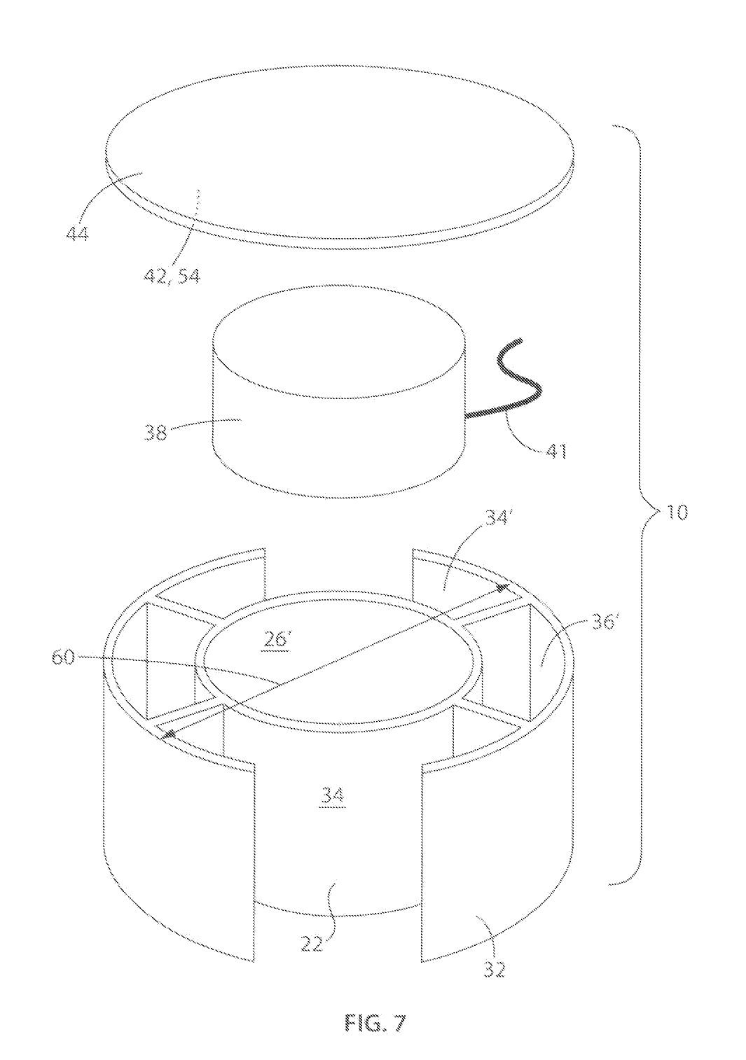

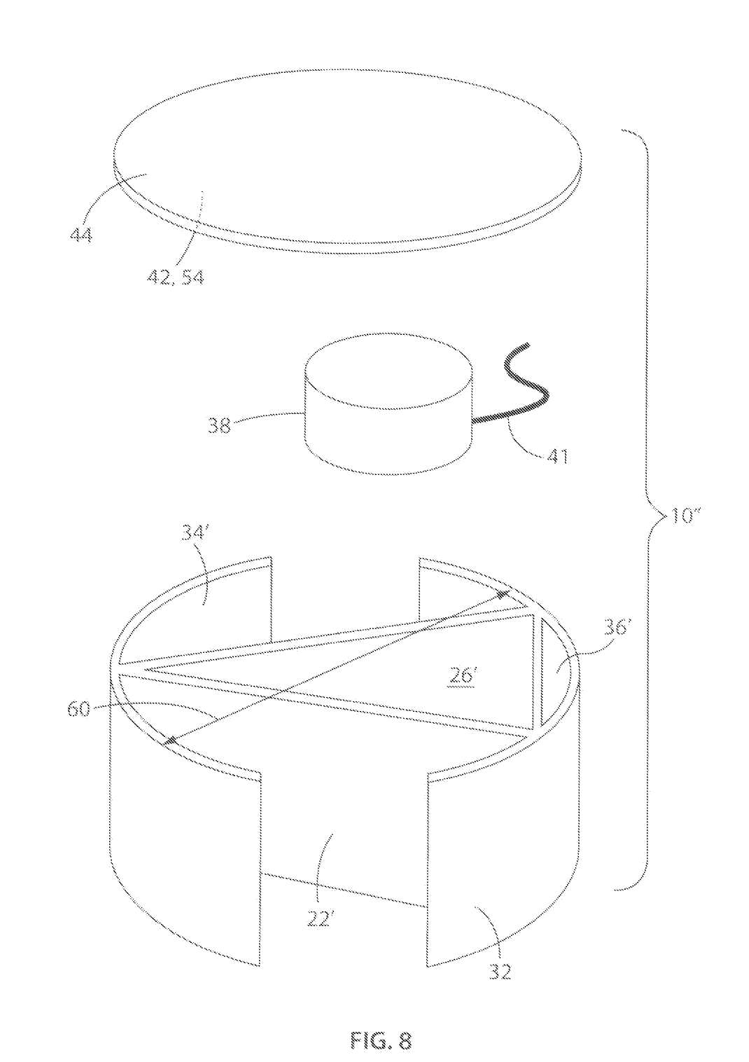

Referring now to FIGS. 7 and 8, representative alternate embodiments of the sensor assembly 10′ and 10″ are described. In the embodiment shown in FIG. 7, the sensor pocket 26′ is round. In the embodiment shown in FIG. 8, the sensor pocket 26″ is triangular. In such embodiments, the epoxy receiving pockets 34′ and the dead spaces 36′ have characteristic forms, as shown in the figures. Of course, any number of shapes can be contemplated for the sensor or the housing. Although not convenient, in that a form of a hole 50 that is not round is difficult to form in asphalt, the exterior form of the sensor assembly 10 need not be round, but could be square or triangular or any other appropriate shape (note, a non-circular hole, although difficult to form in pavement, would have the added advantage of preventing rotation of the housing 16′ within the hole).

In an advantage, epoxy pockets 34 on the side of your housing 16 secure the housing and ensure that it cannot rotate once installed.

In another advantage, the oversize cover 44 which spans the sensor cavity, and rests on an outer lip helps ensure that the epoxy seal sealing the cover 44 to the housing 16 is somewhat outboard of the hole 50 which better ensures that epoxy 40 does not seep into the housing 16 and so facilitates recovery or reuse of the sensor 38.

In another advantage, besides the labor costs saved, significantly less epoxy is needed for in the installation. Using current installation methods, manufacturers typically send out one tube of “FABICK” Epoxy for every sensor 38 shipped to the field. Such tubes currently cost $22.50 each. With the sensor assembly and installation method of the invention, approx. ½ of the total amount of epoxy 40 is needed per install. Thus, using the assembly and method of the invention, only one tube of “FABICK” Epoxy is required for every two sensors. This would result in a $22.50 savings per lane or per sensor pair.

Because of the significant reduction in the amount of epoxy 40 used to secure the sensors 38, the assembly 10 and method 100, 130 of the invention reduces the amount of epoxy 40 needed such that the savings justify the use of the invention on this grounds alone, apart from the possibility of salvaging a sensor 38 for reuse or repair.

An object of the invention is to provide a sensor assembly 10 that facilitates sensor recovery.

Another object of the invention is to provide a sensor assembly 10 and method 100, 130 of installation and removal that permits sensor recovery and reuse.

Moreover, the invention contemplates the use, sale and/or distribution of any goods, services or information having similar functionality described herein.

The specification and figures are to be considered in an illustrative manner, rather than a restrictive one and all modifications described herein are intended to be included within the scope of the invention claimed, even if such is not specifically claimed at the filing of the application. Accordingly, the scope of the invention should be determined by the claims appended hereto or later amended or added, and their legal equivalents rather than by merely the examples described above. For instance, steps recited in any method or process claims may be executed in any order and are not limited to the specific order presented in any claim. Further, the elements and/or components recited in any apparatus claims may be assembled or otherwise operationally configured in a variety of permutations to produce substantially the same result as the present invention. Consequently, the invention is not limited to the specific configuration recited in the claims.

Benefits, other advantages and solutions mentioned herein are not to be construed as critical, required or essential features or components of any or all the claims.

As used herein, the terms “comprises”, “comprising”, or any variation thereof, are intended to refer to a non-exclusive listing of elements, such that any process, method, article, composition or apparatus of the invention that comprises a list of elements does not include only those elements recited, but may also include other elements described in this specification. The use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or otherwise adapted by the skilled artisan to other design without departing from the general principles of the invention.

The patents and articles mentioned above are hereby incorporated by reference herein, unless otherwise noted, to the extent that the same are not inconsistent with this disclosure.

Other characteristics and modes of execution of the invention are described in the appended claims.

Further, the invention should be considered as comprising all possible combinations of every feature described in the instant specification, appended claims, and/or drawing figures which may be considered new, inventive and useful/industrially applicable. The copyrights in this application or any appendix hereto are owned by the Applicant(s) or their assignee and, with respect to express Licensees of the rights defined in one or more claims herein, no implied license is granted herein to use the invention as defined in the remaining claims. Further, vis-à-vis third parties, including the public, no express or implied license is granted to reproduce, prepare derivative works, distribute copies, display, or otherwise use this patent specification, inclusive of the appendix hereto and any computer program comprised therein, except as an appendix to a patent issuing hereon.

Multiple variations and modifications are possible in the embodiments of the invention described here. Although certain illustrative embodiments of the invention have been shown and described here, a wide range of modifications, changes, and substitutions is contemplated in the foregoing disclosure. While the above description contains many specifics, these should not be construed as limitations on the scope of the invention, but rather as exemplifications of one or another preferred embodiment thereof. In some instances, some features of the present invention may be employed without a corresponding use of the other features. Accordingly, it is appropriate that the foregoing description be construed broadly and understood as being given by way of illustration and example only, the spirit and scope of the invention being limited only by the claims which ultimately issue in this application.

### ELEMENT LIST

10 enclosed sensor assembly

12 a road

14 top surface of road

16 housing

38 sensor

44 an upper cover

20 flat bottom portion (20) of housing

22 first side wall portion

32 second side wall portion

24 periphery of housing

26 sensor enclosing pocket

30 an upper interface portion of the housing

34 lateral epoxy receiving pocket

36 dead spaces

30 epoxy

42 upper cover interface.

46 flat surface of flat bottom portion 20 of the housing 16

48 lower flat surface of a sensor assembly receiving hole

50 sensor assembly receiving hole

52 flat upper surface of the upper interface portion 30

56 diameter of cover 44

58 seal

60 diameter of the upper interface portion 30

62 cylindrical recesses

64 side wall of hole 50

66 chisel

70 flat bottom of hole 50

72 upper rim of the hole 50

74 corrugated channels

76 top edge of installed cover

100 method of installation

102 to 122, steps of the above installation method

130 method of removing

What is claimed is:

1. An enclosed sensor assembly (10) for permanent mounting within a road (12) flush with the top surface (14) thereof, the sensor assembly comprising:
(a) a housing (16) comprising:
i) a flat bottom portion (20);
ii) first side wall portions (22) attached to the flat bottom portion (20) at the periphery (24) thereof, which, together with the flat bottom portion, defines a sensor enclosing pocket (26) having an upper interface portion (30);
iii) second side wall portions (32) attached to the first side wall portions (22) and laterally extending from the first side wall portions so as to define at least one lateral epoxy receiving pocket (34) and, optionally, dead spaces (36) adjacent the sensor pocket (26) which help isolate the sensor pocket against entry of epoxy (30);
(b) a sensor (38) installed in the sensor pocket (26); and
(c) a cover (44) having an upper cover interface (42) abutting against the upper interface portion (30) to substantially enclose the sensor enclosing pocket (26)

2. The sensor assembly of claim 1, wherein sensor wires (40) for power and/or communication extend out of the housing through an access hole (42) for connecting to other devices (not shown).

3. The sensor assembly (10) of claim 1, wherein a flat surface (46) of the flat bottom portion (20) aids in aligning the housing (16) against a lower flat surface (48) of a sensor assembly receiving hole (50).

4. The sensor assembly (10) of claim 1, wherein the upper interface portion (30) comprises a flat upper surface (52).

5. The sensor assembly (10) of claim 1, wherein the upper cover interface (42) comprises a corresponding flat surface (54).

6. The sensor assembly (10) of claim 1, wherein the upper cover interface (42) has a diameter (56) greater than a diameter (60) of the upper interface portion (30).

7. The sensor assembly (10) of claim 1, herein the cover (44) is made of corrugated plastic.

8. The sensor assembly (10) of claim 1, wherein the assembly is adapted to be held against rotation in a sensor assembly receiving hole (50) by epoxy (30).

9. A sensor housing for permanent mounting within a road flush with the top surface thereof, the housing comprising:
(a) a flat bottom portion;
(b) first side wall portions attached to the flat bottom portion at the periphery thereof, which, together with the flat bottom portion, defines a sensor enclosing pocket having an upper interface portion;
(c) second side wall portions attached to the first side wall portions and laterally extending from the first side wall portions so as to define at least one lateral epoxy receiving pocket and, optionally, dead spaces adjacent the sensor pocket which help isolate the sensor pocket against entry of epoxy; and
(d) a cover (44) having an upper cover interface (42) abutting against the upper interface portion (30) to substantially enclose the sensor enclosing pocket (26).

10. The sensor housing of claim 9, wherein the flat surface aids in aligning the housing against a lower flat surface of a hole.

11. The sensor housing of claim 9, wherein the upper interface portion comprises a flat surface.

12. The sensor housing of claim 9, wherein the upper cover interface comprises a corresponding flat surface.

13. The sensor housing of claim 9, wherein the upper cover interface has a diameter greater than that of the upper interface portion.

14. The sensor assembly of claim 9, wherein the upper cover is made of corrugated plastic.

15. A method of installing a road sensor so as to permit removal and reuse thereof, the method comprising the steps of:
(a) transporting the sensor housing of claim 8 to an install site, along with a sensor, epoxy and appropriate tools;
(b) forming, such as by boring, a blind hole having a substantially flat bottom to a depth that approximates a height of the sensor housing and of a diameter defining a sidewall, the diameter larger than a diameter of the sensor housing;
(c) installing the sensor housing in the hole, wherein the cylindrical sidewalls orient themselves with the corresponding cylindrical surfaces of the bored hole;
(d) inserting a sensor in the sensor pocket of the sensor housing;
(e) optionally injecting epoxy in the at least one epoxy receiving pocket;
(f) covering the sensor housing with the upper cover interface so as to substantially enclose the sensor enclosing pocket;
(g) optionally, inserting a seal between an edge of the cover and a sidewall of the hole so as to seal the cover in the hole;
(h) applying sufficient epoxy to the upper cover interface to ensure that the epoxy bridges a gap between the upper cover interface and an upper rim of the hole, consequently sealing the sensor in the sensor receiving pocket and, if not already done, applying sufficient epoxy to enter and fill the at least one epoxy receiving pocket; and
(i) allowing the epoxy to set before use.

16. The method of claim 15, wherein after the inserting step, the method includes the step of passing any sensor wires (40) for power and/or communication through an access hole (42) in the housing, for connecting to other devices (not shown).

17. The method of claim 15, wherein the method includes the step of cutting the upper cover to tightly fit an upper portion of the hole while abutting against the upper interface of the housing so as to prevent seepage of epoxy into the sensor pocket.

18. The method of claim 15, wherein the upper cover is made of corrugated plastic in order that the cutting to fit exposes corrugation channels enables the further step of the epoxy wicking into exposed corrugations which channel excess epoxy away from the sensor pocket.

19. (canceled)
